(19) United States
(12) Patent Application Publication
(10) Pub. No.: US 2012/0111376 A1
(43) Pub. Date: May 10, 2012

(54) DEVICE FOR PRE-RINSING OBJECTS IN AN APPLIANCE UTILIZING LINE PRESSURE OF A FLUID SUPPLY

(76) Inventors: Brian WORRASANGASILPA, Louisville, KY (US); James Klump, Crestwood, KY (US); Craig Vitan, Louisville, KY (US); Eric Burns, Louisville, KY (US)

(21) Appl. No.: 12/941,453

(22) Filed: Nov. 8, 2010

(51) Int. Cl. B08B 3/04

(52) U.S. Cl. 134/104.2

(57) ABSTRACT

Embodiments of an appliance for washing objects are described in which the appliance utilizes line pressure of a fluid supply to fill the appliance with a washing fluid, wherein the washing fluid is dispersed onto objects in the appliance before the washing fluid is captured in the enclosure. In one embodiment, the appliance comprises a fill element, which receives the washing fluid directly from a fluid inlet. The fill element comprises an array of spray jets, which are arranged to disperse the washing fluid into the enclosure.

### BACKGROUND OF THE INVENTION

The subject matter disclosed herein relates generally to appliances, and more particularly, to appliances that are configured to utilize line pressure of a fluid supply to disperse a washing fluid and to fill the appliance.

Appliances such as household dishwashers operate by way of several fill and drain cycles. During each of these cycles, washing fluid such as water flows into a wash tub, heats to a pre-set temperature, and then circulates in a manner that cleans the objects (e.g., dishes, dishware, etc.) disposed therein. When the cleaning cycle is complete, the washing fluid drains from the appliance and fresh washing fluid flows into the appliance for the start of a new washing cycle.

The washing fluid is often obtained from an outside supply such as a municipal water supply found in a house, apartment, office building, and similar residential and commercial buildings. To fill the appliance, the washing fluid is typically conducted through a tube or other conduit. This tube often terminates at the wash tub so that the fresh washing fluid spills into the tub directly from the tube.

At the point where the appliance is coupled to the outside supply, the washing fluid exhibits a pressure often referred to as an inlet or line pressure. In some examples, this pressure is dissipated during filling of the appliance such as by way of a valve or other constructive element (e.g., a fill funnel), and in particular, the pressure is dissipated during the fill cycles to a low level, e.g., ambient pressure. However, the reduction of the pressure wastes residual energy of the washing fluid that could be utilized such as for pre-rinsing the objects.

There is therefore a need for an appliance that is configured to utilize the energy in the washing fluid at its inlet or line pressure and that directs the washing fluid onto the objects to be washed by the appliance.

### BRIEF DESCRIPTION OF THE INVENTION

Embodiments of the appliances that are discussed below are configured not only to fill the appliance with the washing fluid from the fluid supply but also at the same time to disperse the washing fluid onto objects in the appliance. This configuration captures the energy in the washing fluid, converting the pressure of the fluid into high-velocity spray that is useful during operation of the appliance. Moreover, use of the washing fluid as a pre-cleaning and/or rinsing agent during the fill stage of the wash cycle can reduce the consumption of energy and washing fluid, while improving the efficiency of the appliance by rinsing the objects before implementation of any subsequent wash cycles.

Further discussion of these concepts, briefly outlined above, is provided below in connection with one or more embodiments.

In one embodiment, an appliance comprises a wash zone in which an object to be cleaned can be positioned and a basin below the wash zone. The appliance also comprises a fluid fill system coupled to a fluid inlet and positioned to disperse a washing fluid directly from the fluid inlet so the washing fluid traverses the wash zone before being captured in the basin.

In another embodiment, a dishwasher comprises a fluid inlet configured to receive a washing fluid from a fluid supply. The dishwasher also comprises a fluid fill system coupled to the fluid inlet and configured to transfer the washing fluid directly and at line pressure from the fluid inlet to a basin. The dishwasher further comprises a recirculation system coupled to the basin, the recirculation system comprising a recirculation element and a pump that is configured to circulate the washing fluid from the basin to the recirculation element. In on example, the fluid fill system is configured to disperse the washing fluid so the washing fluid traverses a wash zone in which an object to be washed is positioned before being captured in the basin.

### BRIEF DESCRIPTION OF THE DRAWINGS

Reference is now made briefly to the accompanying drawings, in which:

FIG. 1 is a schematic diagram of an exemplary embodiment of an appliance.

FIG. 2 is a front view of another exemplary embodiment of an appliance.

FIG. 3 is a front view of yet another exemplary embodiment of an appliance.

FIG. 4 is a top view of still another exemplary embodiment of an appliance.

FIG. 5 is a side view of still yet another exemplary embodiment of an appliance.

FIG. 6 is a side, perspective, partial broken view of a dishwasher embodying one or more of concepts of the present disclosure, such as the concepts related to the appliances of FIGS. 1-5.

FIG. 7 is a schematic diagram of an example of a control configuration for use with an appliance such as the appliances of FIGS. 1-6.

FIG. 8 is a flow diagram of an exemplary operational cycle for an appliance such as the appliances of FIGS. 1-6.

Where applicable like reference characters designate identical or corresponding components and units throughout the several views, which are not to scale unless otherwise indicated.

### DETAILED DESCRIPTION OF THE INVENTION

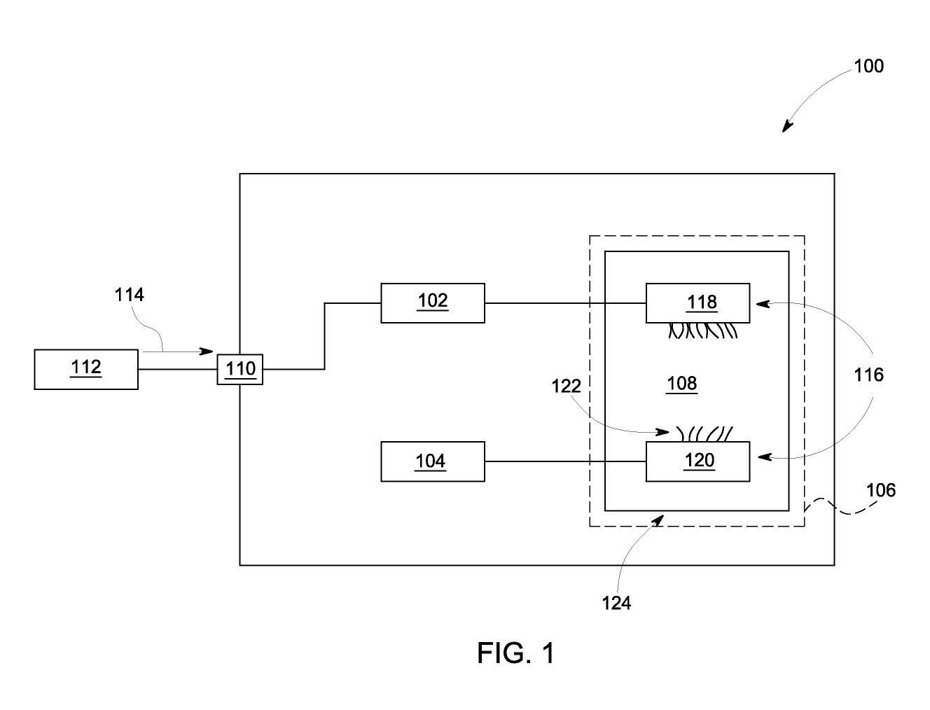

By way of example, and with reference now to FIG. 1, there is depicted a schematic diagram of an exemplary embodiment of an appliance 100. The appliance 100 comprises a fluid fill system 102 and a fluid recirculation system 104, both of which are configured to dispense fluid into an enclosure 106 so as to traverse a wash zone 108 in which objects (e.g., dishes, dishware, and articles of clothing) to be washed are positioned. The appliance 100 has a fluid inlet 110, which is coupled to a fluid supply 112 such as a water supply (e.g. municipal and/or well) associated with a home, office, and other residential and commercial settings.

The fluid supply 112 provides an inlet washing fluid 114, which flows in the present example directly through the fluid fill system 102 and into the wash zone 108. In one embodiment, each of the fluid fill system 102 and the fluid recirculation system 104 comprises a dispensing element 116 such as a fill element 118, which is used to disperse the inlet washing fluid 114. A recirculation element 120 is also provided to circulate a re-circulated washing fluid 122. The re-circulated washing fluid 122 is in one example the inlet washing fluid 114 which, having traversed the wash zone 108 during operation of the appliance 100, is captured in a lower portion 124 of the enclosure 106.

Embodiments of the appliance 100 are configured to capitalize on the pressure of the inlet washing fluid 114 that enters the appliance 100 from the fluid supply 112. The fluid fill system 102 is configured, for example, to conduct the inlet washing fluid 114 directly from the fluid inlet 110 to the fill element 118. In one example, the inlet washing fluid 114 does not pass through any other intervening components before it reaches the fill element 118. In another example, the inlet washing fluid 114 passes through a valve or other flow control device, but is generally directed to the fill element 118 with little interruption. In one embodiment, direct flow of the inlet washing fluid 114 from the fluid inlet 110 to the fill element 118 can be characterized in that the inlet washing fluid 114 is not subject to contamination, such as by way of food particles, or to other adulteration such as by an additive (e.g., detergents). Rather the fluid that is dispersed into the wash zone 108 is generally as clean and/or uncontaminated as the fluid provided by the supply to which the appliance 100 is coupled.

The fill element 118 disperses the inlet washing fluid 114 about the wash zone 108, thereby causing the inlet washing fluid 114 to impinge on one or more of the objects that are disposed in the wash zone 108. In one example, the fill element 118 is configured such as proximate the top of the enclosure 106 to disperse the inlet washing fluid 114 at least through the center of the wash zone 108. In another example, the inlet washing fluid 114 is directed perpendicular to the wash zone 108. This direction causes the inlet washing fluid 114 to traverse across the wash zone 108 before it is directed and/or captured in the lower portion 124 such as by gravity and/or contact with one of the opposing walls for the enclosure 106.

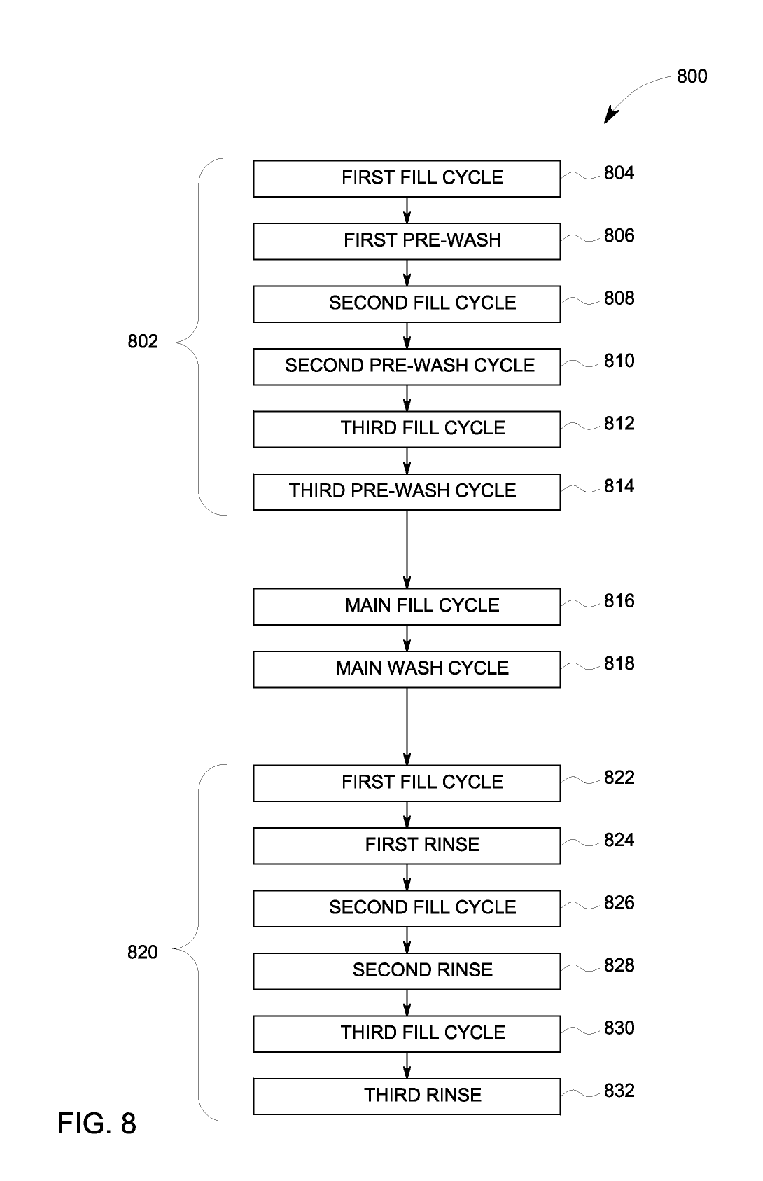

Particular to one embodiment of the appliance 100, the fill element 118 is configured to increase the velocity of the inlet washing fluid 114 as the inlet washing fluid 114 passes through the fill element 118 and into the wash zone 108. The inventors have identified such configurations as beneficial because the pressure of the inlet washing fluid 114 at the fluid inlet 110, which is nominally the line pressure or pressure provided by the fluid supply 112, is useful to generate spray velocities at the fill element 118 that are sufficient to remove particulates (such as fool soil) from the objects in the wash zone 108. Moreover, whereas this residual energy of the inlet washing fluid 114 is not typically captured and/or utilized in conventional systems (e.g., household dishwashers), embodiments of the appliance 100 can channel this energy such as for use during one or more wash cycles, as illustrated in the exemplary operational cycle 800 that is discussed in connection with FIG. 8 below.

When directed at the objects in the wash zone 108, the fill element 118 is used to pre-rinse the objects in the wash zone 108. Pre-rinsing can loosen, dislodge, and/or wholly remove particulates, thereby improving the efficiency of the operational cycle by, e.g., reducing one or more of the number, length, and intensity of the wash cycles required during operation of the appliance 100. Efficiency of the appliance 100 is further improved because the relatively low turbidity of the inlet washing fluid 114 (as compared to, e.g., the turbidity of the re-circulated washing fluid 122) permits construction of the fill element 118 to direct the inlet washing fluid 114 onto the objects at higher velocity and at trajectories that can improve and expand pre-rinsing coverage. For example, and as mentioned above, fluids with low turbidity such as the inlet washing fluid 114 are unlikely to include, if at all, particulates with nominal dimensions that exceed about 1 mm. The unlikely occurrence of large particles permits configurations of the fill element 118 such as with a plurality of openings (not shown) that are smaller, more densely arranged, and/or more numerous than openings, e.g, in the recirculation element 120. By contrast, the re-circulated washing fluid 122 may include larger particles indicative e.g., of food particles from dishes and dishware, that accumulate as re-circulated washing fluid 122 is pumped into the recirculation element 120 and dispersed into the enclosure 106.

Location and configuration of the fill element 118 can vary by way of, for example, positions relative to the wash zone 108. The fill element 118 can be positioned above, below, and about the periphery of the wash zone 108, as well as combinations thereof. Complementary fluid-carrying components such as tubing, fittings, and valves are used to fluidly couple the fill element 118 to the fluid inlet 110, wherein suitable components can be selected based on the position of the fill element 118. In one embodiment, it is further contemplated that the fill element 118, in whole or in part, can be incorporated into the construction of the appliance 100. In one example, the fill element 118 can be integrally formed into at least one wall of the enclosure 106 so that the inlet washing fluid 114 is injected into the wash zone 108 through the walls.

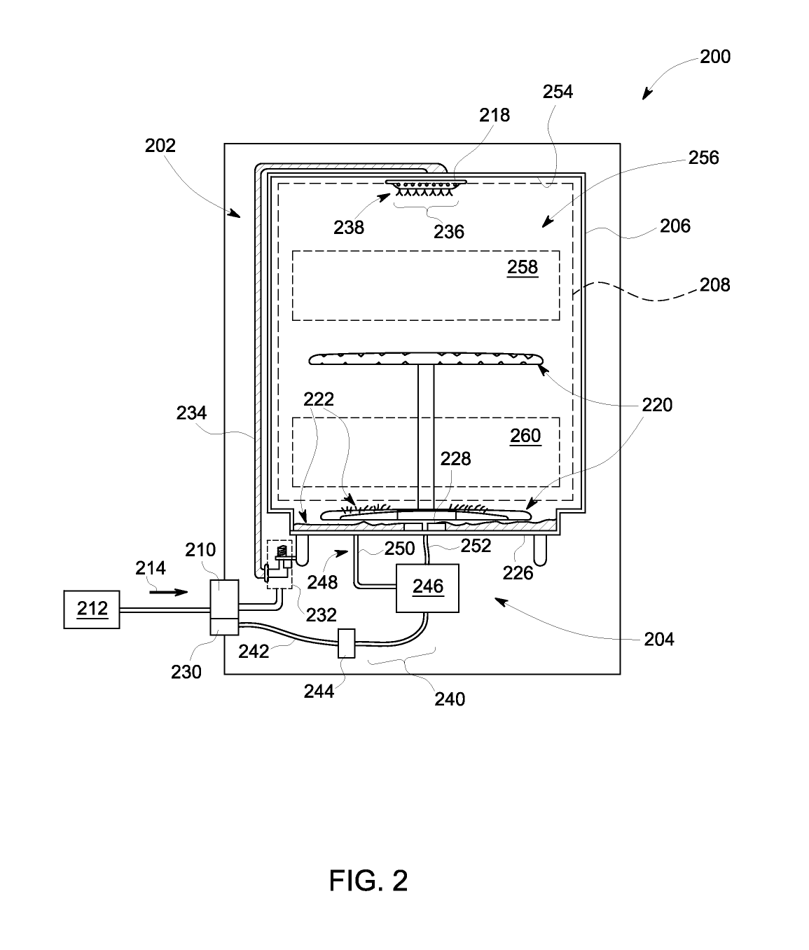

Turning next to FIG. 2, there is depicted another exemplary embodiment of an appliance 200 that comprises a fluid fill system 202 and a fluid recirculation system 204. The appliance 200 has an enclosure 206 in which is found a wash zone 208. A fluid inlet 210 is coupled to a fluid supply 212, which provides an inlet washing fluid 214 that is dispensed into the enclosure 206 via a fill element 218. Also depicted in FIG. 2 is a recirculation element 220, which is coupled to and/or incorporated into the fluid recirculation system 204 so as to dispense a re-circulated washing fluid 222 within the enclosure 206.

In one embodiment, the appliance 200 is configured with a basin 226 and a heating element 228, which is disposed inside of the enclosure 206. These components are used to elevate the temperature of the re-circulated washing fluid 222, which is preferred for cleaning soiled objects (e.g., dishes and dishware) (not shown) in the appliance 200. A fluid outlet 230 is secured to drainage or other means for disposing of wastewater in, e.g., a house or an office. Particular to one embodiment of the appliance 200, the fluid inlet 210 permits ingress of the inlet washing fluid 214 into the appliance 200, and more particularly, the fluid fill system 202 is coupled directly to the fluid inlet 210 to facilitate filling of the basin 226 in accordance with the concepts disclosed herein.

Also depicted is a valve 232 that is coupled to the fluid inlet 210, wherein the valve 232 is used to control the flow of the inlet washing fluid 214. A fill conduit 234 is coupled to the valve 232 and to the fill element 218, thereby placing in fluid communication and facilitating the flow of the inlet washing fluid 214 between the fluid supply 212 and the fill element 218. In one embodiment, the fill element 218 comprises an array 236 with a plurality of openings, or a plurality of fill spray jets 238, through which the inlet washing fluid 214 is injected into the enclosure 206.

The fluid recirculation system 204 is equipped with a fluid distribution system 240, which is coupled to the recirculation element 220, the basin 226, and the fluid outlet 230 via a fluid outlet conduit 242 and a check valve 244. In one embodiment, the fluid distribution system 240 comprises a pump 246 that is used to pressurize and distribute the re-circulated washing fluid 222 among the components of the fluid distribution system 240. The pump 246 is coupled to a conduit matrix 248 that is constructed of tubes, pipes, fittings, valves, and related elements that are useful to transport fluids such as the re-circulated washing fluid 222. The conduit matrix 248 is configured with a basin drain 250, which is coupled to the basin 226, and a spray inlet 252 that is coupled to the recirculation element 220.

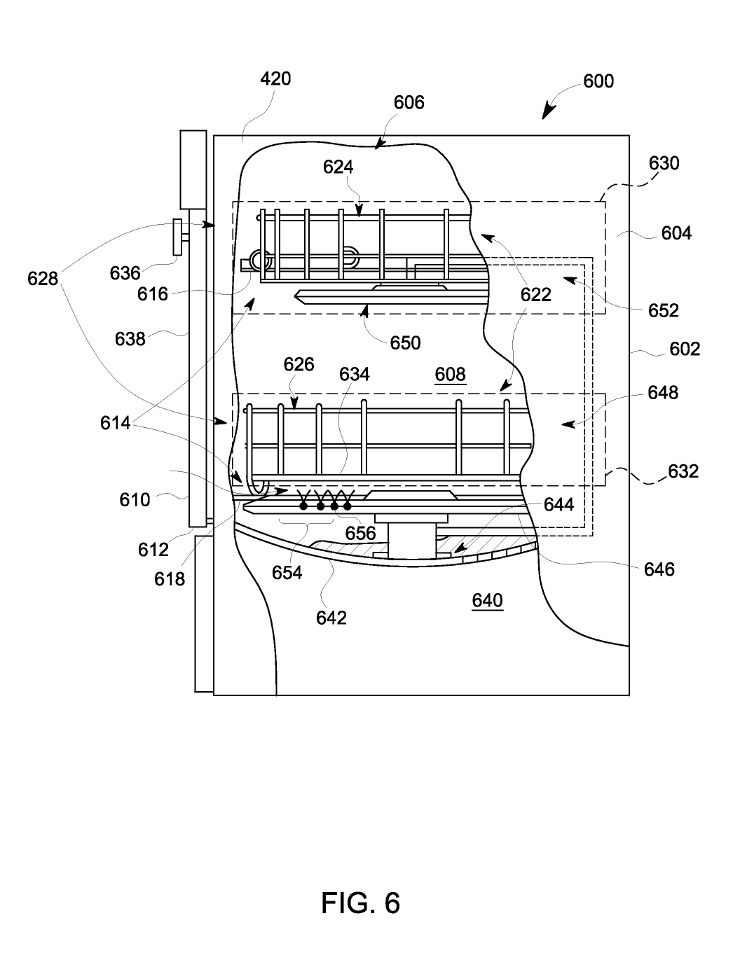

The enclosure 206 comprises an inner wall 254, which defines a cavity 256. The cavity 256 surrounds the wash zone 208, which is separated into an upper or first wash zone 258 and a lower or second wash zone 260. The wash zone 208 defines the portions (or areas) inside of the cavity 256 in which objects (e.g., dishes and dishware) are positioned, e.g., for washing by the appliance 200. These portions can include the entire inner volume defined by the cavity 256. As indicated by the upper wash zone 258 and the lower wash zone 260, these portions can also be particularly located within the cavity 256. In one example, the upper wash zone 258 and the lower wash zone 260 correspond to the location of the objects that are to be cleaned in the enclosure 206. This location is often defined by racks (e.g., the racks 622 of FIG. 6) or other implements that are used to support the objects in the enclosure 206.

As discussed in connection with the appliance 100 (FIG. 1) above, configurations of the appliance 200 utilize the pressure of the fluid supply 212, or a first fluid supply, to dispense the inlet washing fluid 214 into and about the wash zone 208. In one embodiment, the inlet washing fluid 214 under line pressure is dispersed from the fill element 218 throughout the wash zone 208 before being captured in the basin 226. At least one fill element 218 can be configured, for example, so that the inlet washing fluid 214 is dispersed at least in the upper wash zone 258. Other ones of the fill elements 218 can also be included in the appliance 200 so that the inlet washing fluid 214 is dispersed into the lower wash zone 260. Still other configurations are contemplated in which the inlet washing fluid 214 that is dispersed into the upper wash zone 258 disseminates or otherwise traverses the wash zone 208, including the upper wash zone 258 and the lower wash zone 260, before being captured in the basin 226.

Dispersal of the inlet washing fluid 214 is facilitated by the fill spray jets 238 on the fill element 218, which can be designed so that the inlet washing fluid 214 exits the fill element 218 having certain spray characteristics. These spray characteristics are generally related to the pressure of the inlet washing fluid 214, and more particularly the design of the fill spray jets 238 are provided so as to effectuate these characteristics in response to line pressure of the inlet washing fluid 214. By way of example, the diameter of each of the fill spray jets 238 is selected so that the inlet washing fluid 214 exhibits one or more certain spray velocities. Likewise the fill spray jets 238 are oriented to achieve one or more spray trajectories such as to disperse the inlet washing fluid 214, under line pressure, variously within the cavity 256. In one construction the array 236 comprises fill spray jets 238 that disperse the inlet washing fluid 214 at varying levels of spray velocity and in varying directions and/or with varying spray trajectories.

During operation in one exemplary implementation, the valve 232 is actuated to a first position to permit the flow of inlet washing fluid 214 to the fill element 218. The inlet washing fluid 214 is thereafter injected into the cavity 256, wherein in one construction the fill spray jets 238 are configured to disperse the inlet washing fluid 214 variously throughout the wash zone 208. The inlet washing fluid 214 that is dispersed in the wash zone 208 is captured in the basin 226, wherein this captured fluid is used in the fluid recirculation system 204 to further clean and sanitize any objects that are found in the enclosure 206. In one implementation, the valve 232 is actuated to a second position to stop the flow of the inlet washing fluid 214 in response to a fill level or fluid level that is in the basin 226. The fluid level can be monitored by way of a sensor or similar device that is sensitive to the amount of fluid in the basin 226, or in alternative configurations the valve 232 is actuated based on a pre-determined time period as measured by, e.g., a timing circuit.

Fluid captured in the basin 226, also considered a second fluid supply, is distributed by the fluid distribution system 240 such as by activating the pump 246, which draws fluid from the basin 226 via the basin drain 250. The pump 246 distributes by way of the spray inlet 252 the fluid to the recirculation element 216 where it is dispersed into the enclosure 206. In one implementation, the pump 246 is activated so as to cause continuous re-circulation of the fluid. The period of operation for the pump 246 is determined in accordance with, for example, the wash cycle implemented by the appliance 200 or other pre-determined criteria of operation for the appliance 200.

Completion of the wash cycle changes the operation of the fluid distribution system 240 from a first operation in which the fluid in the basin 226 is recirculated to a second operation in which the fluid is drained from the basin 226 and out of the appliance 200. In one embodiment, fluid that flows from the pump 246 is diverted from the spray inlet 252 to the fluid outlet 230. Diverting the fluid can occur by way of a valve, group of valves, or other device(s) that prevents the flow of fluid out of the spray inlet 252 and directs the flow of fluid to the fluid outlet 230.

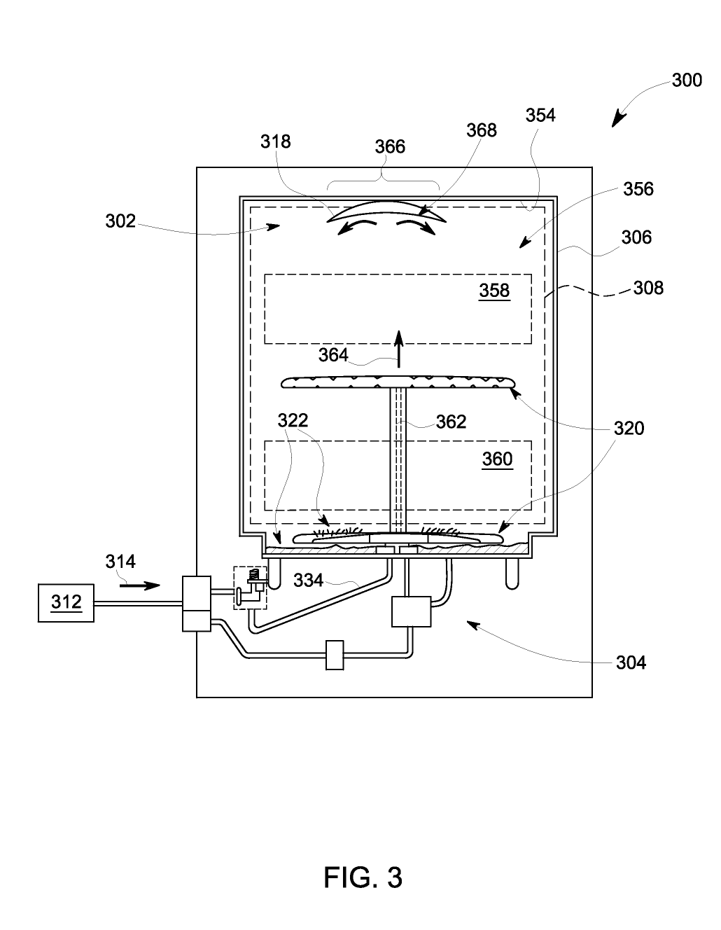

Referring next to FIG. 3, there is provided yet another exemplary embodiment of an appliance 300, wherein like numerals are used to identify like components as between FIGS. 2 and 3. The appliance 300 comprises a fluid fill system 302, a recirculation system 304, an enclosure 306, and a wash zone 308. The fluid fill system 302 is coupled to a fluid supply 312 that provides an inlet washing fluid 314. The appliance 300 further includes a fill element 318, a recirculation element 320, and a fluid conduit 334, which is coupled to the recirculation element 320. The appliance 300 also includes an inner wall 354, which defines a cavity 356 in which is found an upper or first wash zone 358 and a lower or second wash zone 360.

Pertinent to the present example, the recirculation element 320 comprises a fluid passage 362 through which flows the inlet washing fluid 314. This flow forms an inlet fluid jet 364 that rises substantially upwardly from the recirculation element 320. Embodiments of the appliance 300 are configured so that the inlet fluid jet 364 is directed onto the fill element 318, and in one construction the fill element 318 includes a deflector 366 with an arctuate configuration 368 that is useful to deflect the inlet fluid jet 364 towards the wash zone 308, and particularly into the upper wash zone 358 and the lower wash zone 360 in the enclosure 306.

Characteristics of the arctuate configuration 368 can be selected to modify the coverage of the inlet washing fluid 314 that is dispersed in the enclosure 306. Likewise configurations of the dispensing element 316, and in particular the outlet at which the inlet fluid jet 364 is ejected, can provide for increased and improved operation at the line pressure of the inlet washing fluid 314. Such configurations eliminate the need for any additional pump or other devices to increase the pressure of the inlet washing fluid 314 as contemplated herein.

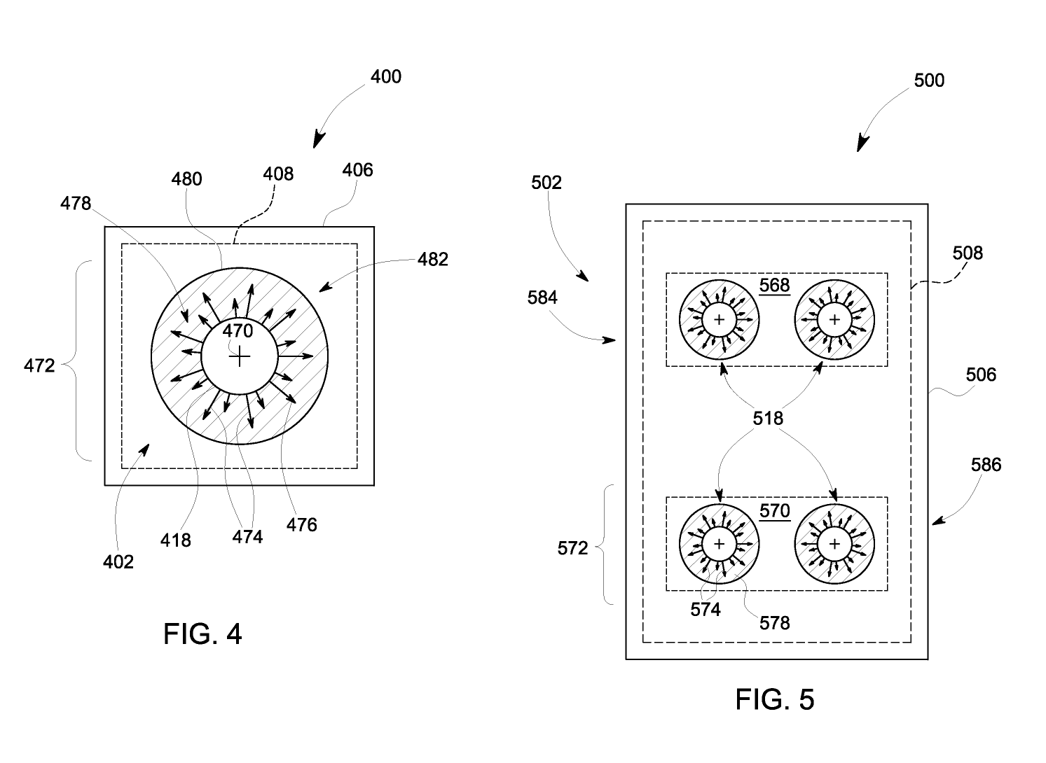

To further clarify these concepts, reference is now directed to FIGS. 4 and 5, in which is illustrated, respectively, a top view (FIG. 4) of an exemplary embodiment of an appliance 400 and a side view (FIG. 5) of an exemplary embodiment of an appliance 500. The appliances 400 and 500 are representative of one or more embodiments of the appliances 100, 200, and 300 discussed above. However, while only those components that are necessary to the discussion of FIGS. 4 and 5 are provided below, the concepts and components discussed in connection with the embodiments of FIGS. 1-3, as well as those concepts contemplated within the scope and spirit of the present disclosure, are likewise applicable to the discussion that follows below.

The appliances 400 and 500 are provided to illustrate in schematic form one or more implementations of the fluid fill system (e.g., the fluid fill system 102, 202, 302) discussed above. In one embodiment, and with reference now to FIG. 4, the appliance 400 is shown with a fluid fill system 402, an enclosure 406, a wash zone 408, and a fill element 418. The fill element 418 is aligned with a central axis 470, which in the present example identifies the center of the wash zone 408. The fill element 418 is configured to form a dispersal pattern 472 with a plurality of spray trajectories 474. Each of the spray trajectories 474 terminates at a spray location 476, which describes the general location (and/or direction) at which the spray trajectories 474 traverses the wash zone 408.

The dispersal pattern 472 has a coverage area 478 with an outer boundary 480 and which defines the extent to which the dispersal pattern 472 covers a cross-sectional area 482 of the wash zone 408. As discussed above, the size of the coverage area 478 is related to the configuration of the fill element 418 such as by way of the arrangement, location, and other features of the spray jets (e.g., the fill spray jets 238 (FIG. 2) and/or the deflector (e.g., the deflector 366 (FIG. 3)). In one example, the coverage area 478 covers at least about 50% of the cross-sectional area 482. In another example, the coverage area 478 covers from about 35% to about 70% of the cross-sectional area 482.

The inventors recognize, however, that the extent of the coverage afforded by any particular configuration of the fill element 418 can vary. Embodiments of the appliance 400 can, for example, utilize more than one fill element 418 so as to effectively increase the extent of coverage in excess of about 70%. In one example, a plurality of fill elements 418 can be implemented, wherein each of the fill elements 418 covers at least 25% of the cross-sectional area 482, but wherein each is disposed about, e.g., the central axis 470, so as to collectively provide coverage of almost 100% of the cross-sectional area 482.

An example of one implementation in which multiple fill elements (e.g., the fill elements 418) are used is found in FIG. 5. The appliance 500 in FIG. 5 comprises a fluid fill system 502, an enclosure 506, a wash zone 508, and a number of fill elements 518. The wash zone 508 includes an upper or first wash zone 568 and a lower or second wash zone 570, which as discussed above identify positions at which object to be washed are positioned in the enclosure 506. Each of the fill elements 518 is configured to cause a dispersal pattern 572 with a coverage area 578. In the present example, the fill elements 518 are separated into an upper or first set 584 and a lower or second set 586. The locations of the upper set 584 and the lower set 586 correspond, respectively, to the upper wash zone 568 and the lower wash zone 570.

With continued reference to FIG. 5, and also FIG. 4, each of the fluid fill system 402 (FIG. 4) and the fluid fill system 502 (FIG. 5) are coupled to a fluid inlet (not shown). The fluid inlet provides an inlet washing fluid, which is conducted directly to the various fill elements (e.g., the fill element 418 and the fill elements 518) and which is dispersed by way of the fill elements into the wash zone (e.g., the wash zones 408 and 508). In one embodiment, each of the individual fill elements are connected to the fluid inlet using a single conduit (not shown). This single conduit can include the necessary components (e.g., fittings, t-fittings, splitters, etc.) to facilitate the transport of the inlet washing fluid as contemplated herein. Other embodiments of the appliances 400 and 500 may also use individual conduits for each of the fill elements 518, wherein one conduit transports the inlet washing fluid directly from the fluid inlet to the respective fill element.

Turning next to FIG. 6, it is noted that the configurations of the fluid fill systems (e.g., the fluid fill system 102, 202, 302, 402, and 502) as well as other concepts of the present disclosure can be implemented on a variety of appliances. Another exemplary appliance is described below in connection with FIG. 6, in which there is depicted a side, elevation view of a dishwasher 600 partially broken away. The fluid fill systems (e.g., the fluid fill system 102, 202, 302, 402, and 502) and the fluid recirculation systems (e.g., the fluid recirculation system 104, 204, and 304) described above and contemplated herein may be practiced in the dishwasher 600, as well as other configurations and types of appliances other than just the dishwasher 600 (and the appliance 100, 200, 300, 400, and 500 above). Although not shown in the details of FIG. 6, the fluid fill system and/or the recirculation system are implemented using similar components, features, implements, and concepts as discussed with reference to FIGS. 1-5 above. Therefore details of these components are not provided in the discussion below, unless necessary to clarify particular subject matter described in connection with FIG. 6 and/or embodiments of the dishwasher 600.

By way of example, the dishwasher 600 includes an enclosure 602 with a cabinet 604 having a tub 606 therein and forming a wash chamber 608. The tub 606 includes a front opening (not shown in FIG. 6) and a door 610 with a hinged bottom 612 such as for movement between a normally closed vertical position (shown in FIG. 6) wherein the wash chamber 608 is sealed shut for washing operation, and a horizontal open position (not shown) for loading and unloading of dishwasher contents.

Guide rails 614 including an upper guide rail 616 and a lower guide rail 618 are mounted on tub side walls 620. The guide rails 614 accommodate one or more racks 622 such as an upper rack 624 and a lower rack 626 (hereinafter, “the racks”), respectively. Each of the racks is located in a wash zone 628 (e.g., the wash zones 108, 208, 308, 408, and 508) such as an upper or first wash zone 630 (e.g., the upper wash zone 258 and 358) and a lower or second wash zone 632 (e.g., the lower wash zone 260 and 360). The racks can be fabricated from known materials into lattice structures including a plurality of elongated members 634, and each is adapted for movement between an extended loading position (not shown) in which at least a portion of the racks are positioned outside the wash chamber 608, and a retracted position (shown in FIG. 6) in which the rack is located inside the wash chamber 608. In one implementation, a silverware basket (not shown) is removably attached to lower rack 626 for placement of silverware, utensils, and the like that are too small to be accommodated by either one or both of the racks contemplated herein.

A control input selector 636 such as a keypad is mounted at a convenient location on an outer face 638 of door 610 and is coupled to known control circuitry. The control input selector 636 is also coupled to other control mechanisms (not shown) for circulating fluids such as water and dishwasher fluid in the tub 606. In one embodiment, the dishwasher 600 includes a machinery compartment 640 located below a bottom sump portion 642 of the tub 606, and a heating element 644 is disposed proximate the bottom sump portion 642.

In one embodiment, the dishwasher 600 includes a lower spray-arm assembly 646, which is mounted for rotation within a lower region 648 of the wash chamber 608 and above bottom sump portion 642 so as to rotate in relatively close proximity to the lower rack 626. A mid-level spray-arm assembly 650 is located in an upper region 652 of the wash chamber 608 in close proximity to the upper rack 624. The mid-level spray-arm assembly 650 is located at a height above the lower rack 626 sufficient to accommodate items such as a dish or platter (not shown) that is placed in lower rack 626. In a further embodiment, an upper spray-arm assembly (not shown) is located above the upper rack 624, again being located at a height sufficient to accommodate items expected to be placed in the upper rack 624, such as a glass (not shown) of a selected height.

One or more of the spray arm assemblies (e.g., the lower spray-arm assembly 646, the mid-level spray-arm assembly 650, and the upper spray-arm assembly) includes discharge ports 654 such as one or more spray jets 656, which are effectively orifices for directing the washing fluid onto objects (e.g., dishes and dishware) located in the racks. The angle of the spray jets 656 can vary, depending in part on the size of the wash chamber 608, the location of the spray arm assembly, and the number of racks, among many factors.

The arrangement of the spray jets 656 in the spray arm assemblies can result in a rotational force as the washing fluid flows through the spray jets 656. The resultant rotation of spray arm assemblies provides coverage of dishes and other dishwasher contents with the washing fluid. In one embodiment, one or more of the spray arm assemblies is likewise configured to rotate, generating in one example a swirling spray pattern above and below, e.g., the upper rack 624.

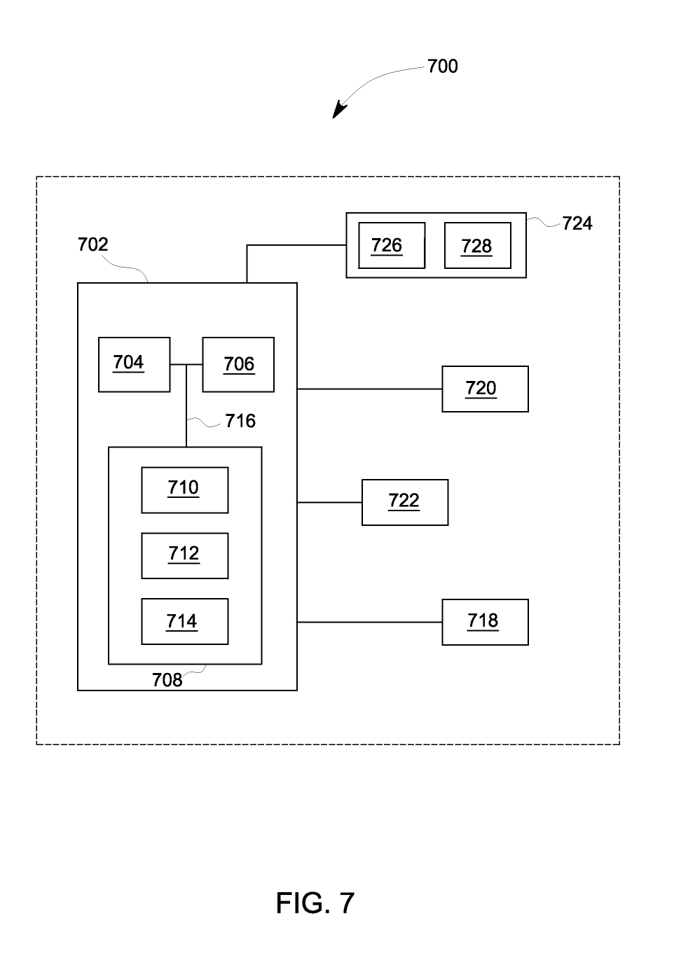

A variety of control configurations and schemes can be used to implement the concepts of the present disclosure. The example of FIG. 7 provides a schematic diagram of one configuration of an exemplary control scheme 700 for use in, e.g., the appliance 100, 200, and 300, and related embodiments (“the appliances”). The control scheme 700 includes a controller 702, which includes a processor 704, a memory 706, and control circuitry 708 configured for general operation of the appliances. The control circuitry 708 comprises a timing circuit 710, a pump control circuit 712, and a valve control circuit 714. All of these components are coupled together and communicate to one another when applicable via one or more busses 716.

The control scheme 700 further includes a valve 718 and a pump 720, as well as a temperature control 722, which is useful to regulate the temperature of the heating elements in the appliance. In one embodiment, the controller 702 is coupled to a control panel 724 that includes one or more wash cycle controls 726 and an indicator control 728. When implemented in the appliances, the controller 702 effectuates operation of various elements of the appliance such as in response to inputs from the control panel 724. The timing circuit 710, of which various configurations are contemplated, is provided to indicate times and time periods to, e.g., change the configuration of the appliance as between the one or more of the wash cycles. These time periods may be selected, in connection with or wholly separate from the configuration of the appliance so as to improve the cleanliness and sanitation of the objects in the appliance as contemplated herein.

The control scheme 700 and its constructive components are configured to communicate amongst themselves and/or with other circuits (and/or devices), which execute high-level logic functions, algorithms, as well as firmware and software instructions. Exemplary circuits of this type include, but are not limited to, discrete elements such as resistors, transistors, diodes, switches, and capacitors, as well as microprocessors and other logic devices such as field programmable gate arrays (“FPGAs”) and application specific integrated circuits (“ASICs”). While all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

The electrical circuits of the controller 702 are sometimes implemented in a manner that can physically manifest logical operations, which are useful to facilitate the timing of the wash cycles of the appliance. These electrical circuits can replicate in physical form an algorithm, a comparative analysis, and/or a decisional logic tree, each of which operates to assign an output and/or a value to the output such as to actuate the valve 718 and/or to activate the pump 720.

In one embodiment, the processor 704 is a central processing unit (CPU) such as an ASIC and/or an FPGA. The processor 704 can also include state machine circuitry or other suitable components capable of receiving inputs from, e.g. the control panel 724. The memory 706 includes volatile and non-volatile memory and can be used for storage of software (or firmware) instructions and configuration settings. Each of the timing circuit 710, the pump control circuit 712, and the valve control circuit 714 can be embodied as stand-alone devices such as solid-state devices. These devices can be mounted to substrates such as printed-circuit boards, which can accommodate various components including the processor 704, the memory 706, and other related circuitry to facilitate operation of the controller 702 in connection with its implementation in the fluid dispensing appliances.

However, although FIG. 7 shows the processor 704, the memory 706, the timing circuit 710, the pump control circuit 712, and the valve control circuit 714 as discrete circuitry and combinations of discrete components, this need not be the case. For example, one or more of these components can be contained in a single integrated circuit (IC) or other component. As another example, the processor 704 can include internal program memory such as RAM and/or ROM. Similarly, any one or more of functions of these components can be distributed across additional components (e.g., multiple processors or other components).

To further exemplify the operation of the appliances discussed above, reference can now be had to FIG. 8 in which there is depicted an exemplary embodiment of an operational cycle 800. Typically, appliances for washing objects employ a series wash cycles, which include pre-wash, wash, and rinse cycles having a preset operation time for washing the objects (e.g., dishes and dishware). As described above, the various systems (e.g., the fluid fill system 102 and 202 and the fluid recirculation system 104 and 204), and in particular the pumps and valves employed therein, may be controlled based upon the desired wash cycle of the appliance.

The operational cycle 800 includes three pre-wash cycles, a main wash cycle and three rinse cycles having a pre-determined running time. However, the appliances may employ a greater or lesser number of such cycles. As illustrated in FIG. 8, an example of these desired wash cycles are provided, wherein the operational cycle 800 includes a pre-wash portion 802, which is used to remove loose particles from the objects in the appliance. The pre-wash portion 802 in the present example is effectuated by a first fill cycle 804, a first pre-wash cycle 806, a second fill cycle 808, a second pre-wash cycle 810, a third fill cycle 812, and a third pre-wash cycle 814. Notably in context of present disclosure is that the fluid fill system 102, 202, and 302 is implemented for each of the fill cycles, i.e., the first fill cycle 804, the second fill cycle 808, and the third fill cycle 812. This implementation can improve the effectiveness of the pre-wash portion 802 by impinging fluid upon the objects during the fill cycles (e.g., the first fill cycle 804, the second fill cycle 808, and the third fill cycle 812).

The operational cycle 800 also includes a main fill cycle 816 and a main wash cycle 818 for washing the objects. Again as with the pre-wash portion 802, the fluid fill systems are utilized to disperse the washing fluid on, among, and in contact with the objects. In addition, the operational cycle 800 includes a rinse portion 820, including in this example a first fill cycle 822, a first rinse cycle 824, a second fill cycle 826, a second rinse cycle 828, a third fill cycle 830, and a third rinse cycle 832.

It is further contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

This written description uses examples to disclose embodiments of the invention, including the best mode, and also to enable any person skilled in the art to practice the invention, including making and using any devices or systems and performing any incorporated methods. The patentable scope of the invention is defied by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An appliance, comprising:
a wash zone in which an object to be cleaned can be positioned;
a basin below the wash zone; and
a fluid fill system coupled to a fluid inlet and positioned to disperse a washing fluid directly from the fluid inlet so the washing fluid traverses the wash zone before being captured in the basin.

2. An appliance according to claim 1, wherein the fluid fill system comprises a plurality of openings through which flows the washing fluid into the wash zone.

3. An appliance according to claim 2, wherein the plurality of openings are incorporated into a wall that forms an enclosure in which the wash zone is located.

4. An appliance according to claim 2, wherein each of the plurality of openings is sized and configured to prevent particulates that exceed about 1 mm to enter the wash zone.

5. An appliance according to claim 1, further comprising.
a fill element from which the washing fluid is injected into the wash zone; and
a conduit coupled to the fill element and to the fluid inlet,
wherein the washing fluid is directed from the fluid inlet to the fill element via the conduit.

6. An appliance according to claim 5, wherein the fill element is disposed above the wash zone.

7. An appliance according to claim 6, wherein the fill element is aligned with a central axis of the wash zone.

8. An appliance according to claim 6, wherein the fill element comprises a plurality of fill spray jets that are configured so the washing fluid is dispersed in a coverage area.

9. An appliance according to claim 8, wherein the coverage area is configured to cover at least 70% of a cross-sectional area of the wash zone.

10. An appliance according to claim 1, further comprising,
a valve disposed between the fluid inlet and the fluid fill system; and
a controller coupled to the valve,
wherein the valve has a first position that permits the washing fluid to flow to the fluid fill system and a second position that prevents the washing fluid to flow to the fluid fill system, and
wherein the controller is configured to change the valve from the first position to the second position when a fill level in the basin is reached.

11. An appliance according to claim 1, wherein the washing fluid captured in the basin is not mixed with an additive.

12. A dishwasher, comprising:
a fluid inlet configured to receive a washing fluid from a fluid supply;
a fluid fill system coupled to the fluid inlet and configured to transfer the washing fluid directly and at line pressure from the fluid inlet to a basin; and
a recirculation system coupled to the basin, the recirculation system comprising a recirculation element and a pump that is configured to circulate the washing fluid from the basin to the recirculation element,
wherein the fluid fill system is configured to disperse the washing fluid so the washing fluid traverses a wash zone in which an object to be washed is positioned before being captured in the basin.

13. A dishwasher according to claim 12, further comprising,
a valve coupled between the fluid inlet and the fluid fill system, the valve having a first position that permits the washing fluid to flow to the fluid fill system and a second position that prevents the washing fluid to flow to the fluid fill system; and
a controller coupled to the pump and to the valve,
wherein the controller is configured to activate the pump when the valve is in the second position.

14. A dishwasher according to claim 12, wherein the fluid fill system is configured to prevent particulates in the washing fluid that exceed about 1 mm to disperse into the basin.

15. A dishwasher according to claim 12, further comprising a wall forming a cavity in which the wash zone is located, wherein the wall is configured to receive and position a rack in the wash zone, and wherein the rack is configured to support objects to be cleaned.

16. A dishwasher according to claim 12, wherein the recirculation system is configured to mix an additive with the washing fluid that is circulated from the basin.

17. A dishwasher according to claim 16, wherein the fluid fill system is configured so the washing fluid does not mix with the additive.

18. A dishwasher according to claim 12, wherein the turbidity of the washing fluid recirculated by the recirculation system is greater than the turbidity of the washing fluid dispersed from the fluid fill system.
